(19) United States
(12) Patent Application Publication
(10) Pub. No.: US 2013/0240735 A1
(43) Pub. Date: Sep. 19, 2013

(54) Method and Apparatus for Detecting Objects by Utilizing Near Infrared Light and Far Infrared Light and Computer Readable Storage Medium Storing Computer Program Performing the Method

(71) Applicants: Hsu-Chun Yen, Taipei City (TW); Che-Yi Lin, Kaohsiung City (TW); Kai-Jun Wang, Kaohsiung City (TW); Chun-Yeh Liao, New Taipei City (TW); Che-Yu Chang, Miaoli County (TW); Sheng-Yang Wu, New Taipei City (TW)

(72) Inventors: Hsu-Chun Yen, Taipei City (TW); Che-Yi Lin, Kaohsiung City (TW); Kai-Jun Wang, Kaohsiung City (TW); Chun-Yeh Liao, New Taipei City (TW); Che-Yu Chang, Miaoli County (TW); Sheng-Yang Wu, New Taipei City (TW)

(73) Assignee: INSTITUTE FOR INFORMATION INDUSTRY, Taipei (TW)

(21) Appl. No.: 13/482,014

(22) Filed: May 29, 2012

(30) Foreign Application Priority Data
Mar. 14, 2012 (TW) 101108684

(51) Int. Cl. G01J 5/02

(52) U.S. Cl. 250/340; 250/338.1

(57) ABSTRACT

In a method for detecting objects by utilizing near infrared (NIR) light and far infrared (FIR) light, an NIR environment image and an FIR environment image generated by photographing a current environment with the NIR light and the FIR light respectively are received. The NIR and FIR environment images are respectively analyzed to obtain several NIR-environment-image analysis values and FIR-environment-image analysis values. A current-environment category is generated according the NIR-environment-image analysis values and the FIR-environment-image analysis values. First object detection information and second object detection information are obtained by respectively performing object-detection onto the NIR environment image and the FIR environment image. Information of at least one detected object in the current environment is obtained according to the current-environment category, the first object detection information and the second object detection information.

### RELATED APPLICATIONS

This application claims priority to Taiwan Application Serial Number 101108684, filed Mar. 14, 2012, which is herein incorporated by reference.

### BACKGROUND

1. Technical Field

The present invention relates to a method and an apparatus for detecting objects and a computer readable storage medium for storing a computer program performing the method. More particularly, the present invention relates to a method and an apparatus for detecting objects by utilizing near infrared (NIR) light and far infrared (FIR) light and a computer readable storage medium for storing a computer program performing the method.

2. Description of Related Art

Traffic accidents are main causes of death, and pedestrians are often casualties in traffic accidents. Especially, when driving at night, drivers see road conditions for safety only by the aid of headlight of vehicles and street lights. However, environment factors (such as rain and mist) and personal factors (such as driver tiredness and poor vision) may affect the drivers to ignore pedestrians, obstacles, thus resulting in traffic accidents. Hence, systems for detecting pedestrians or objects are developed for being installed on vehicles. Such detecting systems can notify drivers about objects around their vehicles, or further take some corresponding actions, such as stopping vehicles.

In prior arts, near infrared (NIR) cameras, far infrared (FIR) cameras or visible light cameras may be utilized to photograph environment near vehicles for object or pedestrian detection. However, if the environment temperature is high (for example, in daytime), the temperature on the ground may be similar to the human-body's temperature, which may cause the FIR cameras to mal-function. Even if at night, the residual heat on the ground or street lights may also affect the FIR cameras to have poor object detection accuracy. Moreover, the NIR cameras and the visible light cameras may be affected by glare generated by headlights of vehicles in the opposite direction, thus lowering object detection accuracy.

### SUMMARY

According to one embodiment of this invention, a method for detecting objects by utilizing near infrared (NIR) light and far infrared (FIR) is provided to determine a category of a current environment according to images shot by utilizing NIR and FIR respectively, and to detect objects according to the category of the current environment. The method for detecting objects includes the following steps:

(a) an NIR environment image and an FIR environment image, which are generated by photographing a current environment with NIR and FIR respectively, are received;

(b) the NIR environment image is analyzed to obtain several NIR-environment-image analysis values corresponding to the NIR environment image;

(c) the FIR environment image is analyzed to obtain several FIR-environment-image analysis values corresponding to the FIR environment image;

(d) a current-environment category is generated according to the NIR-environment-image analysis values and the FIR-environment-image analysis values;

(e) first object detection information is obtained by performing object-detection onto the NIR environment image;

(f) second object detection information is obtained by performing object-detection onto the FIR environment image; and

(g) information of at least one detected object in the current environment is obtained according to the current-environment category, the first object detection information and the second object detection information.

According to another embodiment of this invention, a computer-readable storage medium storing a computer program for performing the steps of the aforementioned method for detecting objects is provided. Steps of the method are as disclosed above.

According to another embodiment of this invention, an apparatus for detecting objects by utilizing NIR light and FIR light is provided to determine a category of a current environment according to images shot by utilizing the NIR light and the FIR light respectively, and to detect objects according to the category of the current environment. The apparatus for detecting objects includes an NIR camera, an FIR camera, an output unit and a processing unit. The processing unit is electrically connected to the NIR camera, the FIR camera and the output unit. The processing unit includes a camera driving module, an analyzing module, a category generating module, an object detecting module and an output module. The camera driving module is used to drive the NIR camera and the FIR camera to photograph a current environment for generating an NIR environment image and an FIR environment image. The analyzing module is used to analyze the NIR environment image to obtain several NIR-environment-image analysis values corresponding to the NIR environment image, and to analyze the FIR environment image to obtain several FIR-environment-image analysis values corresponding to the FIR environment image. The category generating module is used to generate a current-environment category according to the NIR-environment-image analysis values and the FIR-environment-image analysis values. The object detecting module is used to obtain first object detection information by performing object-detection onto the NIR environment image, and to obtain second object detection information by performing object-detection onto the FIR environment image. The output module is used to obtain information of at least one detected object in the current environment according to the current-environment category, the first object detection information and the second object detection information. The output module is used to drive the output unit to output the information of the at least one detected object.

The present invention can achieve many advantages. The object detection result may be precisely generated by taking the detection results generated from the NIR environment image and the FIR environment image into consideration in a suitable way corresponding to the current-environment category. Especially, if the present invention is applied to an apparatus installed on a vehicle, a precise object detection result during vehicle driving can beobtained, thereby preventing the vehicle from hitting objects on the road. Furthermore, since the object detection results are generated in response to different current-environment categories, the object detection result can be generated precisely even under different road conditions.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow chart showing a method for detecting objects utilizing near infrared (NIR) light and far infrared (FIR) light according to one embodiment of this invention; and

FIG. 2 illustrates a block diagram showing an apparatus for detecting objects utilizing NIR and FIR according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

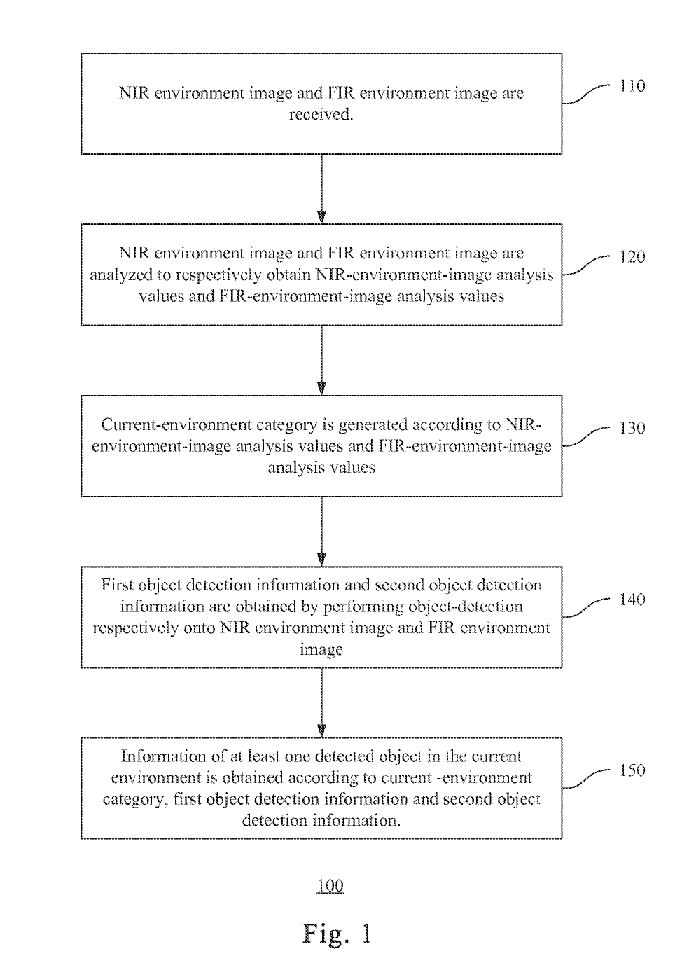

Referring to FIG. 1, FIG. 1 is a flow chart illustrates a method for detecting objects by utilizing near infrared (NIR) light and far infrared (FIR) light according to one embodiment of this invention. In the method for detecting objects, a category of a current environment is determined according to images shot by utilizing the NIR light and the FIR light respectively, and objects are detected according to the category of the current environment. The method for detecting objects may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

The method 100 for detecting objects starts at step 110, where an NIR environment image and an FIR environment image which are generated by photographing a current environment with NIR and FIR respectively are received.

The method 100 continues to step 120, where the NIR environment image and the FIR environment image are analyzed to respectively obtain several NIR-environment-image analysis values corresponding to the NIR environment image and several FIR-environment-image analysis values corresponding to the FIR environment image. For example, the NIR-environment-image analysis values obtained by analyzing NIR environment image may include an average of pixel values of the NIR environment image, a mode of pixel values of the NIR environment image, a deviation value (such as standard deviation, interquartile range, gradient, first order differential, second order differential, etc.) between pixel values of the NIR environment image, a maximum value among pixel values of the NIR environment image, a minimum value among pixel values of the NIR environment image, any other analysis value or combination thereof. The FIR-environment-image analysis values obtained by analyzing FIR environment image may include an average of pixel values of the FIR environment image, a mode of pixel values of the FIR environment image, a deviation value (such as standard deviation, interquartile range, gradient, first order differential, second order differential, etc.) between pixel values of the FIR environment image, a maximum value among pixel values of the FIR environment image, a minimum value among pixel values of the FIR environment image, any other analysis value or combination thereof.

From step 120, the method 100 continues to step 130, where a current-environment category is generated according to the NIR-environment-image analysis values and the FIR-environment-image analysis values.

The method 100 continues to step 140, where first object detection information and second object detection information are obtained by performing object-detection onto the NIR environment image and the FIR environment image respectively. In one embodiment, several objects may be detected from the NIR environment image by scanning the NIR environment image block-by-block to generate the first object detection information. Similarly, several objects may be detected from the FIR environment image by scanning the FIR environment image block-by-block to generate the second object detection information. In some embodiments, at step 140, humans, animals or other type of preset object may be set as the target for object detection. Furthermore, step 140 may be performed before step 120, but this disclosure is not limited thereto.

The method 100 continues to step 150, in which information of at least one detected object in the current environment is obtained according to the current-environment category, the first object detection information and the second object detection information. In some embodiments of step 150, an NIR-environment-image weight factor and an FIR-environment-image weight factor may be obtained according to the current-environment category generated by step 130. Subsequently, the information of the at least one detected object is calculated by taking the first object detection information into consideration with the NIR-environment-image weight factor and taking the second object detection information into consideration with the FIR-environment-image weight factor. In another embodiment of step 150, a calculation method corresponding to the current-environment category generated by step 130 may be utilized to generate the information of the at least one detected object in the current environment, but this disclosure is not limited thereto. Therefore, the object detection result may be precisely generated by taking the detection results generated from the NIR environment image and the FIR environment image into consideration in a suitable way corresponding to the current-environment category.

In one embodiment of this invention, an average of pixel values of the NIR environment image may be utilized to determine that the current environment is in the daytime or at night. Hence, in one embodiment of step 130, when the average of the pixel values of the NIR environment image is greater than an NIR-pixel-value upper limit, the current-environment category is set to a daytime category. Similarly, when the average of the pixel values of the NIR environment image is smaller than an NIR-pixel-value lower limit, the current-environment category is set to a night category. Subsequently, in some embodiments of step 150, the detection results generated from the NIR and FIR environment images may be calculated in a calculation method or with weight factors corresponding to the daytime category or the night category for calculating the information of the at least one detected object in the current environment.

In another embodiment of step 130, a current weather status of the current-environment category may be determined according to the average of the pixel values of the FIR environment image. For example, if the average of the pixel values of the FIR environment image is high, it is determined that the current weather status is hot. Similarly, if the average of the pixel values of the FIR environment image is low, it is determined that the current weather status is cool. Subsequently, the detection results generated from the NIR and FIR environment images may be calculated in a calculation method or with weight factors corresponding to the current weather status at step 150. For instance, when the current weather status is hot, the detection result generated from the FIR environment image may be calculated with a low weight factor; when the current weather status is cool, the detection result generated from the FIR environment image may be calculated with a high weight factor.

In another embodiment at step 130, when the deviation value between the pixel values of the NIR environment image is smaller than an NIR-deviation-value lower limit, the current-environment category is set to a glare category or a misty category. Subsequently, object detection to the NIR environment image at step 140 may be performed after the region of the NIR environment image affected by the glare or the misty is eliminated.

In another embodiment at step 130, a pixel-value difference between the maximum value and the minimum value among the pixel values of the NIR environment image may be calculated. When the pixel-value difference is smaller than a difference lowerlimit, the current-environment category is set to a daytime category. Subsequently, in some embodiments at step 150, the detection results generated from the NIR and FIR environment images may be calculated in a calculation method or with weight factors corresponding to the daytime category for calculating the information of the at least one detected object in the current environment.

In another embodiment of step 130, a pixel-value difference between the maximum value and the minimum value among the pixel values of the FIR environment image may be calculated. When the pixel-value difference is smaller than a difference lower limit, the current-environment category is set to a hot-weather category. Subsequently, in some embodiments at step 150, the detection result generated from the FIR environment image may be calculated with a low weight factor when the current-environment category is set to the hot-weather category. In other embodiments, the categories generated according to different analysis values may be integrated to generate the current-environment category suitable for the current environment, but this disclosure is not limited thereto.

Furthermore, in some embodiments, the method for detecting objects may determine if there are several concentric circles shown on the NIR environment image. For example, the gradient or the second order differential of the pixel values of the NIR environment image may be calculated for determining if there are several concentric circles shown on the NIR environment image. When it is determined that there are the concentric circles shown on the NIR environment image, a region of the NIR environment image on which the concentric circles are shown is taken as a glare region. Subsequently, object detection onto the NIR environment image at step 140 may be performed after the region of the NIR environment image affected by the glare or the misty is eliminated, and thus generating a precise object detection result for the NIR environment image.

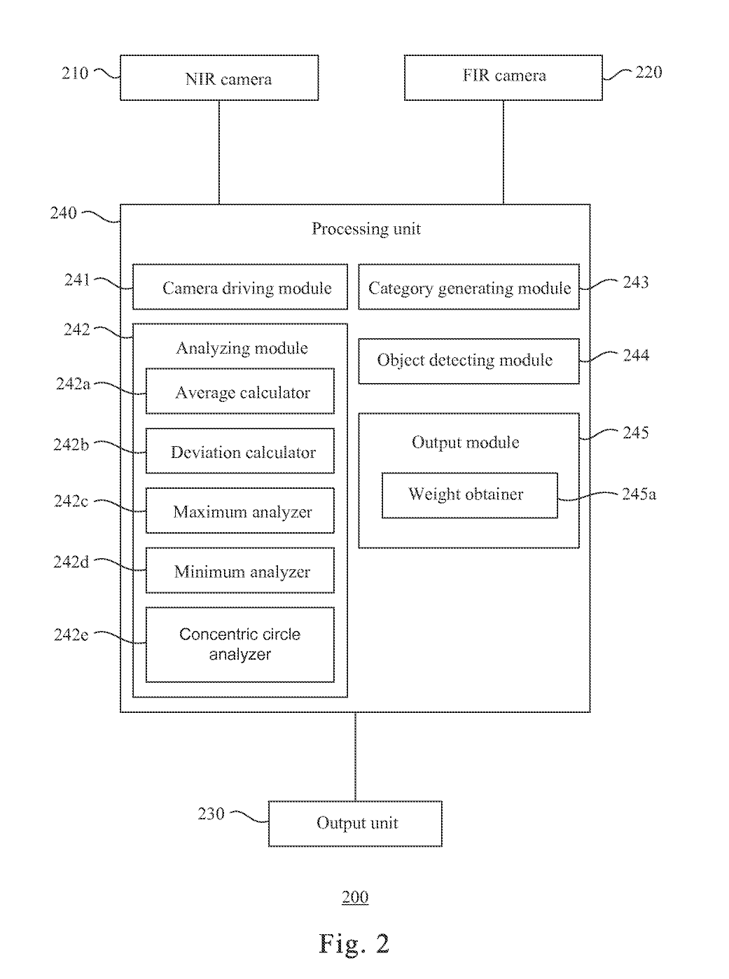

FIG. 2 illustrates a block diagram showing an apparatus for detecting objects by utilizing NIR light and FIR light according to an embodiment of this invention. The apparatus for detecting objects is used to determine a category of a current environment according to images shot by utilizing the NIR light and the FIR light respectively, and detect objects according to the category of the current environment.

The apparatus 200 for detecting objects includes an NIR camera 210, an FIR camera 220, an output unit 230 and a processing unit 240. The processing unit 240 is electrically connected to the NIR camera 210, the FIR camera 220 and the output unit 230. The output unit 230 may be a display unit, a speaker, a data transmission or any other type of output unit.

The processing unit 240 includes a camera driving module 241, an analyzing module 242, a category generating module 243, an object detecting module 244 and an output module 245. The camera driving module 241 drives the NIR camera 210 and the FIR camera 220 to photograph the same current environment to respectively generate an NIR environment image and an FIR environment image.

The analyzing module 242 analyzes the NIR environment image to obtain several NIR-environment-image analysis values corresponding to the NIR environment image. The NIR-environment-image analysis values generated by the analyzing module 242 may include an average of pixel values of the NIR environment image, a mode of pixel values of the NIR environment image, a deviation value (such as standard deviation, interquartile range, gradient, first order differential, second order differential, etc.) between pixel values of the NIR environment image, a maximum value among pixel values of the NIR environment image, a minimum value among pixel values of the NIR environment image, any other analysis value or combination thereof. The analyzing module 242 analyzes the FIR environment image to obtain several FIR-environment-image analysis values corresponding to the FIR environment image. The FIR-environment-image analysis values generated by the analyzing module 242 may include an average of pixel values of the FIR environment image, a mode of pixel values of the FIR environment image, a deviation value (such as standard deviation, interquartile range, gradient, first order differential, second order differential, etc.) between pixel values of the FIR environment image, a maximum value among pixel values of the FIR environment image, a minimum value among pixel values of the FIR environment image, any other analysis value or combination thereof.

The category generating module 243 generates a current-environment category according to the NIR-environment-image analysis values and the FIR-environment-image analysis values.

The object detecting module 244 obtains first object detection information by performing object-detection onto the NIR environment image, and obtains second object detection information by performing object-detection onto the FIR environment image. In some embodiments, the NIR environment image and the FIR environment image may be detected block-by-block to search the objects in NIR environment image and the FIR environment image, such that the first and second object detection information can be generated. In addition, the object detecting module 244 may take humans, animals or other type of preset object as the target for object detection.

The output module 245 obtains information of at least one detected object in the current environment according to the current-environment category, the first object detection information and the second object detection information. Subsequently, the output module 245 drives the output unit 230 to output the information of the at least one detected object utilizing output signals, such as display frames, notice sounds or any other type of output signal. Therefore, the object detection result may be precisely generated by taking the detection results generated from the NIR environment image and the FIR environment image into consideration in a suitable way corresponding to the current-environment category. In one scenario of this invention, the apparatus 200 can be installed on a vehicle to provide a precise object detection result during vehicle driving, thereby preventing the vehicle from hitting objects on the road. Furthermore, since the object detection results are generated in response to the current-environment category, the object detection result can be generated precisely under different road conditions.

In one embodiment of this invention, the output module 245 may include a weight obtainer 245a for obtaining an NIR-environment-image weight factor and an FIR-environment-image weight factor according to the current-environment category. Subsequently, the output module 245 may calculate the information of the at least one detected object by taking the first object detection information into consideration with the NIR-environment-image weight factor and taking the second object detection information into consideration with the FIR-environment-image weight factor. In another embodiment of this invention, the output module 245 may utilize other calculation methods corresponding to the current-environment category to generate the information of the at least one detected object in the current environment, which should not be limited in this disclosure.

In another embodiment of this invention, the analyzing module 242 may include an average calculator 242a for calculating an average of pixel values of the NIR environment image as one of the NIR-environment-image analysis values. Subsequently, when the average of the pixel values of the NIR environment image is greater than an NIR-pixel-value upper limit, the category generating module 243 sets the current-environment category to a daytime category. When the average of the pixel values of the NIR environment image is smaller than an NIR-pixel-value lower limit, the category generating module 243 sets the current-environment category to a night category. Hence, the output module 245 may calculate the information of the at least one detected object in the current environment by calculating the detection results generated from the NIR and FIR environment images in a calculation method or with weight factors corresponding to the daytime category or the night category.

In another embodiment of this invention, the average calculator may calculate an average of pixel values of the FIR environment image as one of the FIR-environment-image analysis values. Hence, the category generating module 243 may determine a current weather status of the current-environment category according to the average of the pixel values of the FIR environment image. For example, if the average of the pixel values of the FIR environment image is high, the category generating module 243 determines that the current weather status is hot. Similarly, if the average of the pixel values of the FIR environment image is low, the category generating module 243 determines that the current weather status is cool. Subsequently, the output module 245 may calculate the information of the at least one detected object in the current environment by calculating the detection results generated from the NIR and FIR environment images in a calculation method or with weight factors corresponding to the current weather status at step 150. For instance, when the current weather status is hot, the output module 245 takes the detection result generated from the FIR environment image with a low weight factor; when the current weather status is cool, the output module 245 takes the detection result generated from the FIR environment image with a high weight factor.

In another embodiment of this invention, the analyzing module 242 may include an deviation calculator 242b for calculating a deviation value between pixel values of the NIR environment image as one of the NIR-environment-image analysis values. When the deviation value between the pixel values of the NIR environment image is smaller than an NIR-deviation-value lower limit, the category generating module 243 sets the current-environment category to a glare category or a misty category. Subsequently, the object detecting module 244 performs object detection onto the NIR environment image after the processing unit 240 eliminates the region of the NIR environment image affected by the glare or the misty.

In another embodiment of this invention, the analyzing module includes a maximum analyzer 242c and a minimum analyzer 242d. The maximum analyzer 242c analyzes and obtains a maximum value among pixel values of the NIR environment image as one of the NIR-environment-image analysis values. The minimum analyzer 242d analyzes and obtains a minimum value among the pixel values of the NIR environment image as one of the NIR-environment-image analysis values. Subsequently, the category generating module 243 calculates a pixel-value difference between the maximum value and the minimum value among the pixel values of the NIR environment image. When the pixel-value difference is smaller than a difference lower limit, the category generating module 243 sets the current-environment category to a daytime category. Subsequently, the output module 245 may calculate the information of the at least one detected object in the current environment by calculating the detection results generated from the NIR and FIR environment images in a calculation method or with weight factors corresponding to the daytime category.

In addition, the maximum analyzer 242 may analyze and obtain a maximum value among pixel values of the FIR environment image as one of the FIR-environment-image analysis values. The minimum analyzer may analyze and obtain a minimum value among the pixel values of the FIR environment image as one of the FIR-environment-image analysis values. Hence, the category generating module 243 may calculate a pixel-value difference between the maximum value and the minimum value among the pixel values of the FIR environment image. When the pixel-value difference is smaller than a difference lower limit, the category generating module 243 sets the current-environment category to a hot-weather category. Subsequently, the output module 245 may calculate the information of the at least one detected object in the current environment by calculating the detection result generated from the FIR environment image with a low weight factor when the current-environment category is set to the hot-weather category.

Moreover, the analyzing module 242 may further include a concentric circle analyzer 242e for determining if there are several concentric circles shown on the NIR environment image. When the concentric circle analyzer 242e determines that there are the concentric circles shown on the NIR environment image, the processing unit 240 takes a region of the NIR environment image on which the concentric circles are shown as a glare region for glare elimination. Subsequently, the object detecting module 244 performs object detection onto the NIR environment image after the processing unit 240 eliminates the region of the NIR environment image affected by the glare.

The present invention can achieve many advantages. The object detection result may be precisely generated by taking the detection results generated from the NIR environment image and the FIR environment image into consideration in a suitable way corresponding to the current-environment category. Especially, if the present invention is applied to an apparatus installed on a vehicle, a precise object detection result during vehicle driving can be provided, thus preventing the vehicle from hitting objects on the road. Furthermore, since the object detection results are generated in response to the current-environment category, the object detection result can be generated precisely under different road conditions.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for detecting objects utilizing near infrared (NIR) light and far infrared (FIR) light, the method comprising:
(a) receiving an NIR environment image and an FIR environment image which are generated by photographing a current environment with the NIR light and the FIR light respectively;
(b) analyzing the NIR environment image to obtain a plurality of NIR-environment-image analysis values corresponding to the NIR environment image;
(c) analyzing the FIR environment image to obtain a plurality of FIR-environment-image analysis values corresponding to the FIR environment image;
(d) generating a current-environment category according to the NIR-environment-image analysis values and the FIR-environment-image analysis values;
(e) obtaining first object detection information by performing object-detection onto the NIR environment image;
(f) obtaining second object detection information by performing object-detection onto the FIR environment image; and
(g) obtaining information of at least one detected object in the current environment according to the current-environment category, the first object detection information and the second object detection information.

2. The method for detecting objects of claim 1, wherein the step (g) comprises:
obtaining an NIR-environment-image weight factor and an FIR-environment-image weight factor according to the current-environment category; and
calculating the information of the at least one detected object by taking the first object detection information into consideration with the NIR-environment-image weight factor and taking the second object detection information into consideration with the FIR-environment-image weight factor.

3. The method for detecting objects of claim 1, wherein:
the NIR-environment-image analysis values comprise an average of a plurality of pixel values of the NIR environment image;
the step (d) comprises:
when the average of the pixel values of the NIR environment image is greater than an NIR-pixel-value upper limit, setting the current-environment category to a daytime category; and
when the average of the pixel values of the NIR environment image is smaller than an NIR-pixel-value lower limit, setting the current-environment category to a night category.

4. The method for detecting objects of claim 1, wherein:
the FIR-environment-image analysis values comprise an average of a plurality of pixel values of the FIR environment image;
the step (d) comprises:
determining a current weather status of the current-environment category according to the average of the pixel values of the FIR environment image.

5. The method for detecting objects of claim 1, wherein:
the NIR-environment-image analysis values comprise a deviation value between a plurality of pixel values of the NIR environment image;
the step (d) comprises:
when the deviation value between the pixel values of the NIR environment image is smaller than an NIR-deviation-value lower limit, setting the current-environment category to a glare category or a misty category.

6. The method for detecting objects of claim 1, wherein:
the NIR-environment-image analysis values comprise a maximum value and a minimum value among a plurality of pixel values of the NIR environment image;
the step (d) comprises:
calculating a pixel-value difference between the maximum value and the minimum value among the pixel values of the NIR environment image; and
when the pixel-value difference is smaller than a difference lower limit, setting the current-environment category to a daytime category.

7. The method for detecting objects of claim 1, wherein:
the FIR-environment-image analysis values comprise a maximum value and a minimum value among a plurality of pixel values of the FIR environment image;
the step (d) comprises:
calculating a pixel-value difference between the maximum value and the minimum value among the pixel values of the FIR environment image; and
when the pixel-value difference is smaller than a difference lower limit, setting the current-environment category to a hot-weather category.

8. The method for detecting objects of claim 1, further comprising:
determining if there are a plurality of concentric circles shown on the NIR environment image; and
when it is determined that there are the concentric circles shown on the NIR environment image, a region of the NIR environment image on which the concentric circles are shown is taken as a glare region.

9. An apparatus for detecting objects by utilizing NIR light and FIR light, the apparatus comprising:
an NIR camera;
an FIR camera;
an output unit; and
a processing unit electrically connected to the NIR camera, the FIR camera and the output unit, wherein the processing unit comprises:
a camera driving module for driving the NIR camera and the FIR camera to photograph a current environment to generate an NIR environment image and an FIR environment image;
an analyzing module for analyzing the NIR environment image to obtain a plurality of NIR-environment-image analysis values corresponding to the NIR environment image, and for analyzing the FIR environment image to obtain a plurality of FIR-environment-image analysis values corresponding to the FIR environment image;
a category generating module for generating a current-environment category according to the NIR-environment-image analysis values and the FIR-environment-image analysis values;
an object detecting module for obtaining first object detection information by performing object-detection onto the NIR environment image, and for obtaining second object detection information by performing object-detection onto the FIR environment image; and
an output module for obtaining information of at least one detected object in the current environment according to the current-environment category, the first object detection information and the second object detection information, and for driving the output unit to output the information of the at least one detected object.

10. The apparatus for detecting objects of claim 9, wherein the output module comprises:
a weight obtainer for obtaining an NIR-environment-image weight factor and an FIR-environment-image weight factor according to the current-environment category,
wherein the output module calculates the information of the at least one detected object by taking the first object detection information into consideration with the NIR-environment-image weight factor and taking the second object detection information into consideration with the FIR-environment-image weight factor.

11. The apparatus for detecting objects of claim 9, wherein:
the analyzing module comprises an average calculator for calculating an average of a plurality of pixel values of the NIR environment image as one of the NIR-environment-image analysis values;
when the average of the pixel values of the NIR environment image is greater than an NIR-pixel-value upper limit, the category generating module sets the current-environment category to a daytime category; and
when the average of the pixel values of the NIR environment image is smaller than an NIR-pixel-value lower limit, the category generating module sets the current-environment category to a night category.

12. The apparatus for detecting objects of claim 9, wherein:
the analyzing module comprises an average calculator for calculating an average of a plurality of pixel values of the FIR environment image as one of the FIR-environment-image analysis values; and
the category generating module determines a current weather status of the current-environment category according to the average of the pixel values of the FIR environment image.

13. The apparatus for detecting objects of claim 9, wherein:
the analyzing module comprises an deviation calculator for calculating a deviation value between a plurality of pixel values of the NIR environment image as one of the NIR-environment-image analysis values; and
when the deviation value between the pixel values of the NIR environment image is smaller than an NIR-deviation-value lower limit, the category generating module sets the current-environment category to a glare category or a misty category.

14. The apparatus for detecting objects of claim 9, wherein:
the analyzing module comprises a maximum analyzer and a minimum analyzer;
the maximum analyzer is used to analyze and obtain a maximum value among a plurality of pixel values of the NIR environment image as one of the NIR-environment-image analysis values;
the minimum analyzer is used to analyze and obtain a minimum value among the pixel values of the NIR environment image as one of the NIR-environment-image analysis values; and
the category generating module is used to calculate a pixel-value difference between the maximum value and the minimum value among the pixel values of the NIR environment image, and sets the current-environment category to a daytime category when the pixel-value difference is smaller than a difference lower limit.

15. The apparatus for detecting objects of claim 9, wherein:
the analyzing module comprises a maximum analyzer and a minimum analyzer;
the maximum analyzer is used to analyze and obtain a maximum value among a plurality of pixel values of the FIR environment image as one of the FIR-environment-image analysis values;
the minimum analyzer is used to analyze and obtain a minimum value among the pixel values of the FIR environment image as one of the FIR-environment-image analysis values; and
the category generating module is used to calculate a pixel-value difference between the maximum value and the minimum value among the pixel values of the FIR environment image, and sets the current-environment category to a hot-weather category when the pixel-value difference is smaller than a difference lower limit.

16. The apparatus for detecting objects of claim 9, wherein the analyzing module comprises:
a concentric circle analyzer for determining if there are a plurality of concentric circles shown on the NIR environment image,
wherein when the concentric circle analyzer determines that there are the concentric circles shown on the NIR environment image, the processing unit takes a region of the NIR environment image on which the concentric circles are shown as a glare region.

17. A computer readable storage medium storing a computer program to perform a method for detecting objects by utilizing NIR light and FIR light, wherein the method for detecting objects comprises:
(a) receiving an NIR environment image and an FIR environment image which are generated by photographing a current environment with the NIR light and the FIR light respectively;
(b) analyzing the NIR environment image to obtain a plurality of NIR-environment-image analysis values corresponding to the NIR environment image;
(c) analyzing the FIR environment image to obtain a plurality of FIR-environment-image analysis values corresponding to the FIR environment image;
(d) generating a current-environment category according to the NIR-environment-image analysis values and the FIR-environment-image analysis values;
(e) obtaining first object detection information by performing object-detection onto the NIR environment image;
(f) obtaining second object detection information by performing object-detection onto the FIR environment image; and
(g) obtaining information of at least one detected object in the current environment according to the current-environment category, the first object detection information and the second object detection information.
